(19) United States
(12) Patent Application Publication
(10) Pub. No.: US 2022/0369411 A1
(43) Pub. Date: Nov. 17, 2022

(54) METHOD OF TRANSMITTING AND RECEIVING NOTIFICATION OF MULTICAST SESSION ACTIVATION

(71) Applicant: Samsung Electronics Co., Ltd., Suwon-si (KR)

(72) Inventor: Anil AGIWAL, Suwon-si (KR)

(21) Appl. No.: 17/741,852

(22) Filed: May 11, 2022

(30) Foreign Application Priority Data
May 12, 2021 (KR) 10-2021-0061620

(51) Int. Cl. H04W 76/27; H04W 68/02; H04W 48/10; H04W 72/12

(52) U.S. Cl. CPC H04W 76/27; H04W 68/02; H04W 48/10; H04W 72/1273

(57) ABSTRACT

A method, performed by a user equipment (UE) in radio resource control (RRC) IDLE state or RRC INACTIVE state is provided. The method includes receiving, from a base station (BS), paging configuration information, receiving, from the BS, physical downlink control channel (PDCCH) based on the paging configuration information, wherein the PDCCH includes scheduling information for physical downlink shared channel (PDSCH), obtaining multicast and broadcast service (MBS) paging message in the PDSCH, and performing procedure to enter RRC connected state, in case that the MBS paging message includes identity of multicast service in which the UE is interested.

### CROSS-REFERENCE TO RELATED APPLICATION(S)

This application is based on and claims priority under 35 U.S.C. § 119(a) of a Korean patent application number 10-2021-0061620, filed on May 12, 2021, in the Korean Intellectual Property Office, the disclosure of which is incorporated by reference herein in its entirety.

### BACKGROUND

### 1. Field

The disclosure relates to a method of transmitting and receiving of multicast session activation.

### 2. Description of Related Art

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation (4G) wireless communication system suffers from lack of resources to meet the growing demand for high speed data services. So fifth generation (5G) wireless communication system (also referred as next generation radio or new radio (NR)) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the user equipments (UEs) having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system, Physical Downlink Control Channel (PDCCH) is used to schedule downlink (DL) transmissions on physical downlink shared channel (PDSCH) and uplink (UL) transmissions on PUSCH, where the Downlink Control Information (DCI) on PDCCH includes: Downlink assignments containing at least modulation and coding format, resource allocation, and hybrid automatic repeat request (HARQ) information related to downlink shared channel (DL-SCH); Uplink scheduling grants containing at least modulation and coding format, resource allocation, and HARQ information related to uplink shared channel (UL-SCH). In addition to scheduling, PDCCH can be used to for: Activation and deactivation of configured PUSCH transmission with configured grant. Activation and deactivation of PDSCH semi-persistent transmission; Notifying one or more UEs of the slot format; Notifying one or more UEs of the physical resource blocks (PRBs) and orthogonal frequency-division multiplexing (OFDM) symbol(s) where the UE may assume no transmission is intended for the UE. Transmission of transmit power control (TPC) commands for PUCCH and PUSCH. Transmission of one or more TPC commands for SRS transmissions by one or more UEs. Switching a UE's active bandwidth part. Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations are signaled by next generation node B (GNB) for each configured bandwidth part (BWP) wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of Transmission configuration indicator (TCI) states. One DL RS ID (SSB or CSI RS) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is QCLed with SSB/CSI RS of TCI state) used by GNB for transmission of PDCCH in the PDCCH monitoring occasions of a search space.

In the fifth generation wireless communication system, next generation node B (gNB) or base station in cell broadcast Synchronization Signal and physical broadcast channel (PBCH) block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the master information block (MIB) and a number of system information blocks (SIBs) where:
the MIB is always transmitted on the BCH with a periodicity of 80 ms and repetitions made within 80 ms and it includes parameters that are needed to acquire SIB1 from the cell.
the SIB1 is transmitted on the DL-SCH with a periodicity of 160 ms and variable transmission repetition. The default transmission repetition periodicity of SIB1 is 20 ms but the actual transmission repetition periodicity is up to network implementation. The scheduling information in SIB 1 includes mapping between SIBs and SI messages, periodicity of each SI message and SI window length. The scheduling information in SIB 1 includes an indicator for each SI message, which indicates whether the concerned SI message is being broadcasted or not. If at least one SI message is not being broadcasted, SIB1 may include random access resources (physical random access channel (PRACH) preamble(s) and PRACH resource(s)) for requesting gNB to broadcast one or more SI message(s).
SIBs other than SIB1 are carried in SystemInformation (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB 1. The cell specific SIB is applicable only within a cell that provides the SIB while the area specific SIB is applicable within an area referred to as SI area, which consists of one or several cells and is identified by systemInformationAreaID.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of transmitting and receiving of multicast session activation.

Additional aspects will be set forth in part in the description which follows and, in part, will be apparent from the description, or may be learned by practice of the presented embodiments.

In accordance with an aspect of the disclosure, a method, performed by a user equipment (UE) in radio resource control (RRC) IDLE state or RRC INACTIVE state, in a wireless communication system is provided. The method includes receiving, from a base station (BS), paging configuration information, receiving, from the BS, physical downlink control channel (PDCCH) based on the paging configuration information, wherein the PDCCH includes scheduling information for physical downlink shared channel (PDSCH), obtaining multicast and broadcast service (MBS) paging message in the PDSCH, and performing procedure to enter RRC connected state, in case that the MBS paging message includes identity of multicast service in which the UE is interested.

In accordance with another aspect of the disclosure, a method, performed by a base station (BS) in a wireless communication system is provided. The method includes transmitting, to a user equipment (UE), paging configuration information, transmitting, to the UE, physical downlink control channel (PDCCH) based on the paging configuration information, wherein the PDCCH includes scheduling information for physical downlink shared channel (PDSCH), transmitting, to the UE, multicast and broadcast service (MBS) paging message via the PDSCH, and performing procedure to enter RRC connected state, in case that the MBS paging message includes identity of multicast service in which the UE is interested.

In accordance with another aspect of the disclosure, a user equipment (UE) in radio resource control (RRC) IDLE state or RRC INACTIVE state is provided. The UE includes a memory, a transceiver, and at least one processor connected with the memory and the transceiver. The at least one processor is configured to receive, from a base station (BS), paging configuration information, receive, from the BS, physical downlink control channel (PDCCH) based on the paging configuration information, wherein the PDCCH includes scheduling information for physical downlink shared channel (PDSCH), obtain multicast and broadcast service (MBS) paging message in the PDSCH, and perform procedure to enter RRC connected state, in case that the MBS paging message includes identity of multicast service in which the UE is interested.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating a method, performed by a user equipment (UE), according to an embodiment of the disclosure;

FIG. 2 is a flowchart illustrating a method, performed by a user equipment (UE), according to an embodiment of the disclosure;

FIG. 3 is a flowchart illustrating a method, performed by a user equipment (UE), according to an embodiment of the disclosure;

FIG. 4 is a flowchart illustrating a method, performed by a user equipment (UE), according to an embodiment of the disclosure;

FIG. 5 is a flowchart illustrating a method, performed by a user equipment (UE), according to an embodiment of the disclosure;

FIG. 6 is a block diagram of a user equipment (UE), according to an embodiment of the disclosure; and

FIG. 7 is a block diagram of a gNB, according to an embodiment of the disclosure;

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While describing the embodiments, technical content that is well known in the related fields and not directly related to the disclosure will not be provided. By omitting redundant descriptions, the essence of the disclosure will not be obscured and may be clearly explained.

For the same reasons, components may be exaggerated, omitted, or schematically illustrated in drawings for clarity. Also, the size of each component does not completely reflect the actual size. In the drawings, like reference numerals denote like elements.

As used herein, the term “and/or” includes any and all combinations of one or more of the associated listed items. Expressions such as “at least one of,” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof.

Advantages and features of one or more embodiments of the disclosure and methods of accomplishing the same may be understood more readily by reference to the following detailed description of the embodiments and the accompanying drawings. In this regard, the various embodiments may have different forms and should not be construed as being limited to the descriptions set forth herein. Rather, these embodiments are provided so that this disclosure will be thorough and complete and will fully convey the concept of the various embodiments to one of ordinary skill in the art, and the disclosure will only be defined by the appended claims.

It will be understood that combinations of blocks in flowcharts or process flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated consecutively may actually be executed substantially concurrently, or the blocks may sometimes be performed in a reverse order according to the corresponding function.

Here, the term “unit” in the embodiments of the disclosure means a software component or hardware component such as a field-programmable gate array (FPGA) or an application-specific integrated circuit (ASIC) and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with a smaller number of components and “units”, or may be divided into additional components and “units”. Furthermore, the components and “units” may be embodied to reproduce one or more central processing units (CPUs) in a device or security multimedia card. Also, in the embodiments, the “unit” may include at least one processor. In the disclosure, a controller may also be referred to as a processor.

A wireless communication system has evolved from providing initial voice-oriented services to, for example, a broadband wireless communication system providing a high-speed and high-quality packet data service, such as communication standards of high speed packet access (HSPA), long-term evolution (LTE) or evolved universal terrestrial radio access (E-UTRA), and LTE-Advanced (LTE-A) of third generation partnership project (3GPP), high rate packet data (HRPD) and ultra mobile broadband (UMB) of 3GPP2, and Institute of Electrical and Electronics Engineers (IEEE) 802.16e. A fifth generation (5G) or new radio (NR) communication standards are being developed with 5G wireless communication systems.

Hereinafter, one or more embodiments will be described with reference to accompanying drawings. Also, in the description of the disclosure, certain detailed explanations of related functions or configurations are omitted when it is deemed that they may unnecessarily obscure the essence of the disclosure. All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies, and thus, the terms used herein have to be defined based on the meaning of the terms together with the description throughout the specification. Hereinafter, a base station may be a subject performing resource assignment of a terminal, and may be at least one of a gNode B, an eNode B, a Node B, a base station (BS), a wireless access unit, a base station controller, and a node on a network. A terminal may include user equipment (UE), a mobile station (MS), a cellular phone, a smart phone, a computer, or a multimedia system capable of performing communication functions, or the like. In the disclosure, a DL is a wireless transmission path of a signal transmitted from a base station to a terminal, and a UL is a wireless transmission path of a signal transmitted from a terminal to a base station. Throughout the specification, a layer (or a layer apparatus) may also be referred to as an entity. Also, hereinbelow, one or more embodiments of the disclosure will be described as an example of an LTE or LTE-A system, but the one or more embodiments may also be applied to other communication systems having a similar technical background or channel form. For example, 5G mobile communication technology (5G, new radio, NR) developed after LTE-A may be included. In addition, the one or more embodiments may be applied to other communication systems through some modifications within the scope of the disclosure without departing from the scope of the disclosure according to a person skilled in the art.

In an LTE system as a representative example of the broadband wireless communication system, an orthogonal frequency division multiplexing (OFDM) scheme is used in a DL and a single carrier frequency division multiplexing (SC-FDMA) scheme is used in a UL. The UL refers to a wireless link through which a terminal, the UE, or a MS transmits data or control signals to a BS or a gNode B, and the DL refers to a wireless link through which a BS transmits data or control signals to a terminal. In such a multiple access scheme, data or control information of each user is classified by generally assigning and operating the data or control information such that time-frequency resources for transmitting data or control information for each user do not overlap each other, that is, such that orthogonality is established.

Terms such as a physical channel and a signal in an existing LTE or LTE-A system may be used to describe methods and apparatuses suggested in the disclosure. However, the content of the disclosure is applied to a wireless communication system, instead of the LTE or LTE-A system.

In the fifth generation wireless communication system, RRC can be in one of the following states: RRC_IDLE, RRC INACTIVE, and RRC_CONNECTED. A UE is either in RRC_CONNECTED state or in RRC_INACTIVE state when an RRC connection has been established. If this is not the case, i.e., no RRC connection is established, the UE is in RRC_IDLE state. The RRC states can further be characterized as follows:

In the RRC_IDLE, a UE specific Discontinuous Reception (DRX) may be configured by upper layers. The UE monitors short Messages transmitted with paging-radio network temporary identifier (P-RNTI) over DCI; monitors a Paging channel for core network (CN) paging using 5G-S-temporary mobile subscriber identity (5G-S-TMSI); performs neighboring cell measurements and cell (re-)selection; acquires system information and can send SI request (if configured); performs logging of available measurements together with location and time for logged measurement configured UEs.

In RRC INACTIVE, a UE specific DRX may be configured by upper layers or by RRC layer; the UE stores the UE Inactive AS context; a radio access network (RAN)-based notification area is configured by the RRC layer. The UE monitors Short Messages transmitted with P-RNTI over DCI; monitors a Paging channel for CN paging using 5G-S-TMSI and RAN paging using full I-RNTI; performs neighboring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC CONNECTED, the UE stores the AS context and transfer of unicast data to/from the UE takes place. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

In the RRC CONNECTED, network may initiate suspension of the RRC connection by sending RRCRelease with suspend configuration. When the RRC connection is suspended, the UE stores the UE Inactive AS context and any configuration received from the network, and transits to RRC INACTIVE state. If the UE is configured with SCG, the UE releases the SCG configuration upon initiating a RRC Connection Resume procedure. The RRC message to suspend the RRC connection is integrity protected and ciphered.

In the fifth generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e., every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all the UEs. The UE identity (i.e., S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e., PDCCH is masked with P-RNTI) over data channel (i.e., PDSCH). SI update and emergency notifications are included in DCI and PDCCH carrying this DCI is addressed to P-RNTI. In the RRC idle/inactive mode the UE monitors one paging occasion (PO) every DRX cycle. In the RRC idle/inactive mode the UE monitors PO in initial DL BWP. In the RRC connected state the UE monitors one or more POs to receive SI update notification and to receive emergency notifications. The UE can monitor any PO in paging DRX cycle and monitors at least one PO in SI modification period. In the RRC idle/inactive mode the UE monitors PO in its active DL BWP. A PO is a set of ‘S’ PDCCH monitoring occasions for paging, where ‘S’ is the number of transmitted SSBs (i.e., the Synchronization Signal and PBCH block (SSB) consists of primary and secondary synchronization signals (PSS, SSS) and PBCH) in cell. The UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (i_s), indicating the index of the PO is determined by i_s=floor(UE_ID/N) mod Ns.
T is DRX cycle of the UE. In RRC_INACTIVE state, T is determined by the shortest of the UE specific DRX value configured by the RRC, the UE specific DRX value configured by non-access stratum (NAS), and a default DRX value broadcast in system information. In RRC_IDLE state, T is determined by the shortest of the UE specific DRX value configured by NAS, and a default DRX value broadcast in system information. If the UE specific DRX is not configured by upper layers (i.e., NAS), the default value is applied.
N: number of total paging frames in T
Ns: number of paging occasions for a PF
PF_offset: offset used for PF determination
UE_ID: 5G-S-TMSI mod 1024
Parameters Ns, nAndPagingFrameOffset, and the length of default DRX Cycle are signaled in SIB1. The values of N and PF_offset are derived from the parameter nAndPagingFrameOffset. If the UE has no 5G-S-TMSI, for instance when the UE has not yet registered onto the network, the UE shall use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI as defined in clause 13 in TS 38.213. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)th PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signaled, the (i_s+1)th PO is a set of ‘S’ consecutive PDCCH monitoring occasions for paging starting from the PDCCH monitoring occasion number indicated by firstPDCCH-MonitoringOccasionOfPO (i.e., the (i_s+1)th value of the firstPDCCH-MonnoringOccasionOfPO parameter). Otherwise, the (i_s+1)^{th} PO is a set of ‘S’ consecutive PDCCH monitoring occasions for paging starting from the (i_s*S)^{th} PDCCH monitoring occasion for paging. ‘S’ is the number of actual transmitted SSBs determined according to parameter ssb-PositionsInBurst signaled in SystemInformationBlock1 received from gNB. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

The PDCCH addressed to P-RNTI carries information according to DCI format 1_0. The following information is transmitted by means of the DCI format 1_0 with CRC scrambled by P-RNTI:
Short Messages Indicator—2 bits according to Table 1.
Short Messages—8 bits according to Table 2. If only the scheduling information for Paging is carried, this bit field is reserved.
Frequency domain resource assignment—┌log₂(N_{RB}^{DL,BWP}(N_{RB}^{DL,DWP}+1)/2)┐ bits. If only the short message is carried, this bit field is reserved.
N_{RB}^{DL,BWP} is the size of CORESET 0
Time domain resource assignment—4 bits. If only the short message is carried, this bit field is reserved.
virtual resource blocks (VRB)-to-PRB mapping—1 bit. If only the short message is carried, this bit field is reserved.
Modulation and coding scheme—5 bits. If only the short message is carried, this bit field is reserved.
Tuberculosis (TB) scaling—2 bits. If only the short message is carried, this bit field is reserved.
Reserved bits—6 bits

TABLE 1
Short Message indicator

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 2 defines Short Message. Bit 1 is the most significant bit.

TABLE 2
Short Message

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or |
| | an ETWS secondary notification and/or a CMAS notification. |
| 3-8 | Reserved |

In the fifth generation wireless communication system, support of multimedia broadcast multicast service (MBMS) is being studied. Multicast services are supported in RRC CONNECTED state. The UE interested in multicast session can be in RRC IDLE or RRC INACTIVE in following scenarios:
The UE has joined a multicast session but the session is started later and the UE is released to RRC IDLE or RRC INACTIVE due to (unicast) data inactivity.
The multicast session has started, but the session is deactivated due to inactivity in the core network and the UE is released to RRC IDLE or RRC INACTIVE due to inactivity in RAN.

The UEs in RRC IDLE or RRC INACTIVE needs to be notified about the multicast session start/activation. So that the UE may enter RRC CONNECTED and starts receiving multicast service packets. The issue is how to notify the UE in RRC IDLE or RRC INACTIVE about the multicast session start/activation.

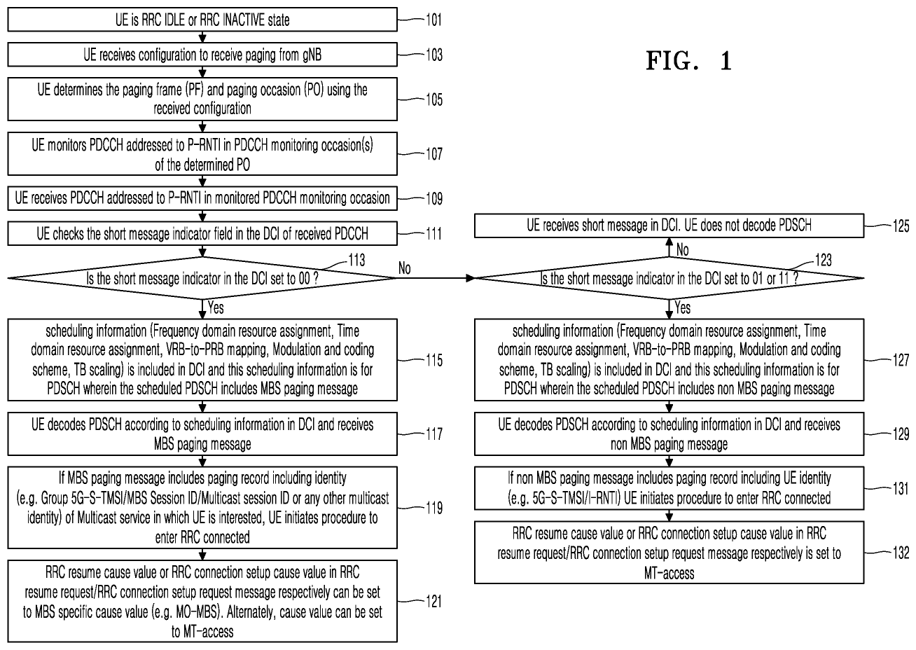

FIG. 1 is a flowchart illustrating a method, performed by a user equipment (UE), according to an embodiment of the disclosure.

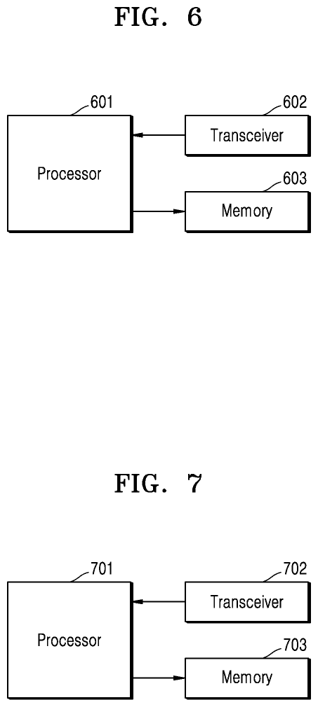

Referring to FIG. 1, a method, performed by a UE, of receiving notification of multicast session activation may include operations 101 through 132. According to various embodiments of the disclosure, operations 101 through 132 may be performed by the processor 601 shown in FIG. 6.

Method 1

In one method of the disclosure, the UE operation in RRC IDLE/RRC INACTIVE is as follows:

In operation 101, the UE is in RRC IDLE or RRC INACTIVE state.

In operation 103, the UE receives the paging channel configuration from the system information (e.g. SIB1) transmitted by the gNB. The paging channel configuration includes number (N) of paging frames in the DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1).

In operation 105, the UE determines the paging frame (PF) and paging occasion (PO) using the configuration received from the gNB. The procedure to determine PF and PO is same as explained earlier.

In operation 107, the UE monitors PDCCH addressed to P-RNTI in PDCCH monitoring occasion(s) of the determined PO.

In operation 109, the UE receives PDCCH addressed to P-RNTI in monitored PDCCH monitoring occasion.

In operation 111, the UE checks the short message indicator field in the DCI of received PDCCH.

In operation 113, if the short message indicator in the DCI is set to 00, the UE performs operation 115 and if the short message indicator in the DCI is not set to 00, the UE performs operation 123.

In operation 115, the UE identify that scheduling information (Frequency domain resource assignment, Time domain resource assignment, VRB-to-PRB mapping, Modulation and coding scheme, TB scaling) is included in DCI and this scheduling information is for PDSCH wherein the scheduled PDSCH includes MBS paging message. The fields, Frequency domain resource assignment, Time domain resource assignment, VRB-to-PRB mapping, Modulation and coding scheme, TB scaling in DCI are not set to reserved values unlike the legacy system where these fields are set to reserved values when short message indicator in the DCI is set to 00.

In operation 117, the UE decodes PDSCH according to scheduling information in DCI and receives MBS paging message.

In operation 119, if the MBS paging message includes paging record including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested, the UE initiates procedure to enter the RRC connected (i.e., connection resume procedure or connection setup procedure as defined in TS 38.331). The RRC resume cause value or RRC connection setup cause value in RRC resume request/RRC connection setup request message respectively can be set to MBS specific cause value (e.g. MO-MBS), so that network is aware that the UE is entering the RRC connected for MBS purpose. Alternately, cause value can be set to MT-access) (operation 121).

In an embodiment, identity (e.g. Group 5G-S-TMSI/MBS Session ID/Multicast session ID or any other multicast identity) of Multicast service in which the UE is interested may be received by the UE before this procedure in NAS message from CN or in RRC message from the gNB while the UE is in the RRC connected state or it can be pre-configured in subscriber identification module (SIM)/USD/universal SIM (USIM).

In operation 123, if the short message indicator in the DCI is set to 01 or 11, the UE performs operation 127 and if the short message indicator in the DCI is not set to 01 or 11, the UE performs operation 125.

In operation 127, the UE identify that scheduling information (Frequency domain resource assignment, Time domain resource assignment, VRB-to-PRB mapping, Modulation and coding scheme, TB scaling) is included in DCI and this scheduling information is for PDSCH wherein the scheduled PDSCH includes non MBS paging message. The fields, Frequency domain resource assignment, Time domain resource assignment, VRB-to-PRB mapping, Modulation and coding scheme, TB scaling in the DCI are not set to reserved values as in the legacy system.

In operation 129, the UE decodes PDSCH according to scheduling information in the DCI and receives non MBS paging message.

In operation 131, if non MBS paging message includes paging record including the UE identity (e.g. 5G-S-TMSI/I-RNTI, the UE initiates procedure to enter RRC connected (i.e., connection resume procedure or connection setup procedure as defined in TS 38.331).

In operation 123, if the short message indicator in the DCI is set to 10, the UE performs operation 125.

In operation 125, the UE identify that scheduling information (Frequency domain resource assignment, Time domain resource assignment, VRB-to-PRB mapping, Modulation and coding scheme, TB scaling) is included in the DCI. The fields, Frequency domain resource assignment, Time domain resource assignment, VRB-to-PRB mapping, Modulation and coding scheme, TB scaling in DCI are set to reserved values as in the legacy system. The UE receives short message in DCI. The UE does not decode the PDSCH.

In one method (i.e., METHOD 1) of the disclosure, the gNB operation is as follows:

In the method, the gNB transmits the paging channel configuration in the system information (e.g. SIB1). The paging channel configuration includes number (N) of paging frames in DRX cycle, number of paging occasions per paging frame, paging frame offset, length of default DRX Cycle. firstPDCCH-MonitoringOccasionOfPO may also be optionally transmitted by the gNB in system information. The gNB also transmits paging search space identifier (pagingSearchSpace) in the system information (e.g. SIB1).

The gNB determines the paging frame (PF) and paging occasion (PO) using the configuration transmitted in system information. The procedure to determine PF and PO is same as explained earlier.

The gNB prepare the DCI for transmitting in PDCCH monitoring occasions of determined PO as follows:

The gNB includes short message indicator in the DCI. If the gNB has MBS paging message for transmission, the gNB sets short message indicator in the DCI to 00. The gNB includes scheduling information (Frequency domain resource assignment, Time domain resource assignment, VRB-to-PRB mapping, Modulation and coding scheme, TB scaling). This scheduling information is for PDSCH wherein the scheduled PDSCH includes MBS paging message.

If the gNB has non MBS paging message for transmission, the gNB sets short message indicator in the DCI to 01 or 11. The gNB includes scheduling information (Frequency domain resource assignment, Time domain resource assignment, VRB-to-PRB mapping, Modulation and coding scheme, TB scaling). This scheduling information is for PDSCH wherein the scheduled PDSCH includes non MBS paging message. The gNB includes short message in the DCI, if short message is available for transmission.

If the gNB has only short message for transmission, the gNB sets short message indicator in the DCI to 10. The gNB includes short message in the DCI. The gNB includes Frequency domain resource assignment, Time domain resource assignment, VRB-to-PRB mapping, Modulation and coding scheme, TB scaling in DCI and these are set to reserved values.

In an embodiment, the gNB transmits PDCCH addressed to P-RNTI in PDCCH monitoring occasions of determined PO. The gNB transmits PDSCH according to scheduling information in the DCI, if the DCI is set to 00, 01 or 10. PDSCH includes MBS paging message if DCI is set 00. PDSCH includes non MBS paging message if DCI is set to 01 or 10. MBS paging message includes paging record(s) including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service. Non MBS paging message includes paging record(s) including the UE identity (e.g. 5G-S-TMSI/I-RNTI).

The above operations of the gNB may be performed by the processor 701 shown in FIG. 7.

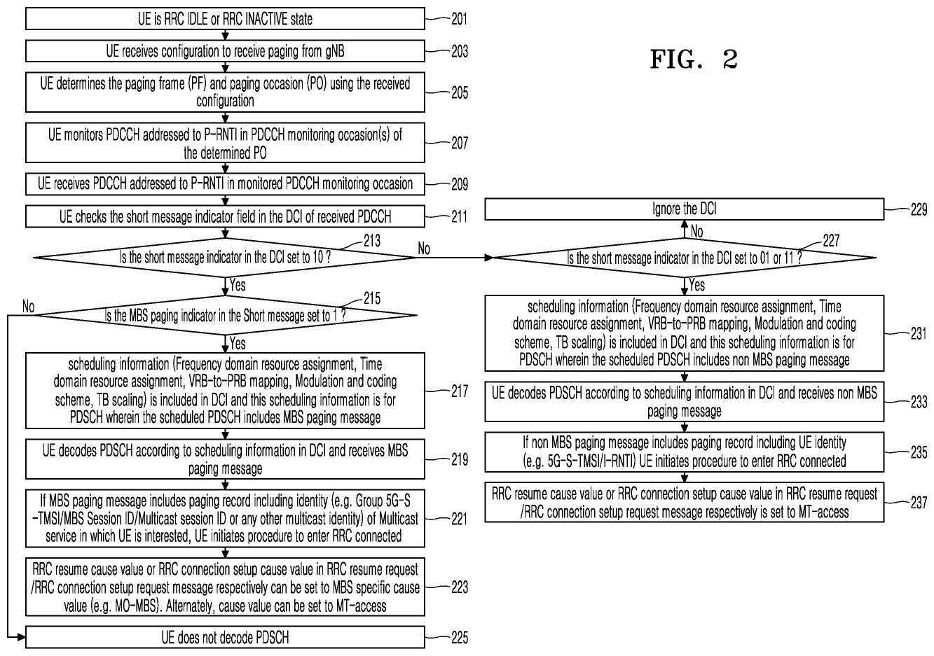

FIG. 2 is a flowchart illustrating a method, performed by a user equipment (UE), according to an embodiment of the disclosure.

Referring to FIG. 2, a method, performed by a UE, of receiving notification of multicast session activation may include operations 201 through 237. According to various embodiments of the disclosure, operations 201 through 237 may be performed by the processor 601 shown in FIG. 6.

Method 2

In one method of the disclosure, the UE operation in RRC IDLE/RRC INACTIVE is as follows:

In operation 201, the UE is in RRC IDLE or RRC INACTIVE state.

In operation 203, the UE receives the paging channel configuration from the system information (e.g. SIB1) transmitted by the gNB. The paging channel configuration includes number (N) of paging frames in DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1).

In operation 205, the UE determines the paging frame (PF) and paging occasion (PO) using the configuration received from the gNB. The procedure to determine PF and PO is same as explained earlier.

In operation 207, the UE monitors PDCCH addressed to P-RNTI in PDCCH monitoring occasion(s) of the determined PO.

In operation 209, the UE receives PDCCH addressed to P-RNTI in monitored PDCCH monitoring occasion.

In operation 211, the UE checks the short message indicator field in the DCI of received PDCCH.

In operation 213, if the short message indicator in the DCI is set to 10, the UE performs operation 215 and if the short message indicator in the DCI is not set to 00, the UE performs operation 227.

In operation 215, the UE receives short message in DCI and the UE checks if MBS paging indicator in short message is set to 1 or not.

If MBS paging indicator in short message is set to 1, the UE performs operation 217 and if MBS paging indicator in short message is not set to 1, the UE performs operation 225.

In operation 217, the UE identify that scheduling information (Frequency domain resource assignment, Time domain resource assignment, VRB-to-PRB mapping, Modulation and coding scheme, TB scaling) is included in DCI and this scheduling information is for PDSCH wherein the scheduled PDSCH includes MBS paging message. The fields, Frequency domain resource assignment, Time domain resource assignment, VRB-to-PRB mapping, Modulation and coding scheme, the TB scaling in the DCI are not set to reserved values unlike the legacy system where these fields are set to reserved values when short message indicator in the DCI is set to 10.

In operation 219, the UE decodes PDSCH according to scheduling information in the DCI and receives MBS paging message.

In operation 221, if the MBS paging message includes paging record including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested, the UE initiates procedure to enter RRC connected (i.e., connection resume procedure or connection setup procedure as defined in TS 38.331). The RRC resume cause value or the RRC connection setup cause value in the RRC resume request/RRC connection setup request message respectively may be set to MBS specific cause value (e.g. MO-MBS), so that network is aware that the UE is entering RRC connected for MBS purpose. Alternately, cause value can be set to MT-access) (operation 223).

In an embodiment, identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested can be received by the UE before this procedure in NAS message from CN or in RRC message from the gNB while the UE is in the RRC connected state or it can be pre-configured in SIM/USD/USIM.

In operation 225, if the MBS paging indicator in short message is set to 0, the UE identify that scheduling information (Frequency domain resource assignment, Time domain resource assignment, VRB-to-PRB mapping, Modulation and coding scheme, TB scaling) is included in the DCI. The fields, Frequency domain resource assignment, Time domain resource assignment, VRB-to-PRB mapping, Modulation and coding scheme, the TB scaling in the DCI are set to reserved values as in the legacy system. The UE does not decode PDSCH.

In operation 227, if the short message indicator in the DCI is set to 01 or 11, the UE performs operation 231 and if the short message indicator in the DCI is not set to 01 or 11, the UE performs operation 229.

In operation 231, the UE identify that scheduling information (Frequency domain resource assignment, Time domain resource assignment, VRB-to-PRB mapping, Modulation and coding scheme, TB scaling) is included in the DCI and this scheduling information is for PDSCH wherein the scheduled PDSCH includes non MBS paging message. The fields, Frequency domain resource assignment, Time domain resource assignment, VRB-to-PRB mapping, Modulation and coding scheme, the TB scaling in the DCI are not set to reserved values as in the legacy system.

In operation 233, the UE decodes PDSCH according to scheduling information in the DCI and receives non MBS paging message.

In operation 235, if non MBS paging message includes paging record including the UE identity (e.g. 5G-S-TMSI/I-RNTI, the UE initiates procedure to enter RRC connected (i.e., connection resume procedure or connection setup procedure as defined in TS 38.331).

In one method (i.e., METHOD 2) of the disclosure, the gNB operation is as follows:

In the method, the gNB transmits the paging channel configuration in the system information (e.g. SIB1). The paging channel configuration includes number (N) of paging frames in the DRX cycle, number of paging occasions per paging frame, paging frame offset, length of default DRX Cycle. firstPDCCH-MonitoringOccasionOfPO may also be optionally transmitted by gNB in system information. The gNB also transmits paging search space identifier (pagingSearchSpace) in the system information (e.g. SIB1).

The gNB determines the paging frame (PF) and paging occasion (PO) using the configuration transmitted in system information. The procedure to determine PF and PO is same as explained earlier. The gNB prepare the DCI for transmitting in PDCCH monitoring occasions of determined PO as follows:

The gNB includes short message indicator in the DCI. If the gNB has MBS paging message for transmission, the gNB sets short message indicator in the DCI to 10. The gNB includes short message in the DCI. The gNB sets MBS paging indicator to 1 in short message. The gNB includes scheduling information (Frequency domain resource assignment, Time domain resource assignment, VRB-to-PRB mapping, Modulation and coding scheme, TB scaling). This scheduling information is for PDSCH wherein the scheduled PDSCH includes the MBS paging message.

If the gNB has non MBS paging message for transmission, the gNB sets short message indicator in the DCI to 01 or 11. The gNB includes scheduling information (Frequency domain resource assignment, Time domain resource assignment, VRB-to-PRB mapping, Modulation and coding scheme, TB scaling). This scheduling information is for PDSCH, wherein the scheduled PDSCH includes non MBS paging message. The gNB includes short message in the DCI, if short message is available for transmission. The gNB sets MBS paging indicator to 0 in short message.

If the gNB has only short message for transmission, the gNB sets short message indicator in the DCI to 10. The gNB includes short message in the DCI. The gNB sets MBS paging indicator to 0 in short message. The gNB includes Frequency domain resource assignment, Time domain resource assignment, VRB-to-PRB mapping, Modulation and coding scheme, the TB scaling in the DCI and these are set to reserved values.

In an embodiment, the gNB transmits PDCCH addressed to P-RNTI in PDCCH monitoring occasions of determined PO. The gNB transmits PDSCH according to scheduling information in the DCI, if the DCI is set to 01 or 10, or if the DCI includes short message and MBS paging indicator in short message is set to 1. The PDSCH includes MBS paging message if the DCI includes short message and MBS paging indicator in short message is set to 1. PDSCH includes non MBS paging message if DCI is set to 01 or 10. The MBS paging message includes paging record(s) including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service. Non MBS paging message includes paging record(s) including UE identity (e.g. 5G-S-TMSI/I-RNTI).

The above operations of the gNB may be performed by the processor 701 shown in FIG. 7.

Method 2A

In one method of the disclosure, the UE operation in RRC_IDLE/RRC INACTIVE is as follows:

In an embodiment, the UE is in RRC_IDLE or RRC_INACTIVE state.

The UE receives the paging channel configuration from the system information (e.g. SIB1) transmitted by the gNB. The paging channel configuration includes number (N) of paging frames in DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1).

The UE determines the paging frame (PF) and paging occasion (PO) using the configuration received from the gNB. The procedure to determine PF and PO is same as explained earlier.

The UE monitors PDCCH addressed to P-RNTI in PDCCH monitoring occasion(s) of the determined PO. The UE receives PDCCH addressed to P-RNTI in monitored PDCCH monitoring occasion.

The UE checks the short message indicator field in the DCI of received PDCCH.

In an embodiment, if the short message indicator in the DCI is set to 10, the UE receives short message in DCI. The UE checks if the MBS paging indicator (or MBS session activation/start indication) in short message is set to 1 or not.

If MBS paging indicator in short message is set to 1, the UE initiates procedure to enter RRC connected (i.e., connection resume procedure or connection setup procedure as defined in TS 38.331). RRC resume cause value or RRC connection setup cause value in RRC resume request/RRC connection setup request message respectively can be set to MBS specific cause value (e.g. MO-MBS), so that network is aware that the UE is entering the RRC connected for MBS purpose. Alternately, cause value can be set to MT-access).

(Alternate) The UE checks if short message indicates paging (or MBS session activation/start indication) for multicast service group in which the UE is interested. The short message may include indication for one or more multicast service group(s) for which paging (or MBS session activation/start indication) is there. Alternately, short message may include a bitmap wherein each bit in bitmap corresponds to a multicast service group and if paging (or MBS session activation/start indication) is there for a multicast service group, the bit corresponding to that group in bit map is set to 1. Identity of Multicast service group can be received by the UE before this procedure in NAS message from the CN or in the RRC message from the gNB while the UE is in the RRC connected state or it can be pre-configured in SIM/USD/USIM. Multicast service group information may be signaled to the UE via CN (e.g. in NAS message) or RAN (e.g. in RRC message or system information). Each multicast session or multicast service may be associated with a multicast service group. Mapping between multicast session or multicast service and multicast service group identity can be signaled to the UE via CN (e.g. in NAS message) or RAN (e.g. in RRC message or system information). If the UE is interested in a multicast session or multicast service, the UE monitors paging (or MBS session activation/start indication) for the corresponding multicast service group.

In an embodiment, MBS paging indicator or MBS session activation/start indication as described above can be there in DCI instead of short message.

If the short message indicator in the DCI is set to 01 or 11, the UE identify that scheduling information (Frequency domain resource assignment, Time domain resource assignment, VRB-to-PRB mapping, Modulation and coding scheme, TB scaling) is included in DCI and this scheduling information is for PDSCH wherein the scheduled PDSCH includes non MBS paging message. The fields, Frequency domain resource assignment, Time domain resource assignment, VRB-to-PRB mapping, Modulation and coding scheme, the TB scaling in DCI are not set to reserved values as in the legacy system. The UE decodes PDSCH according to scheduling information in the DCI and receives non MBS paging message. If the non MBS paging message includes paging record including the UE identity (e.g. 5G-S-TMSI/I-RNTI, the UE initiates procedure to enter RRC connected (i.e., connection resume procedure or connection setup procedure as defined in TS 38.331).

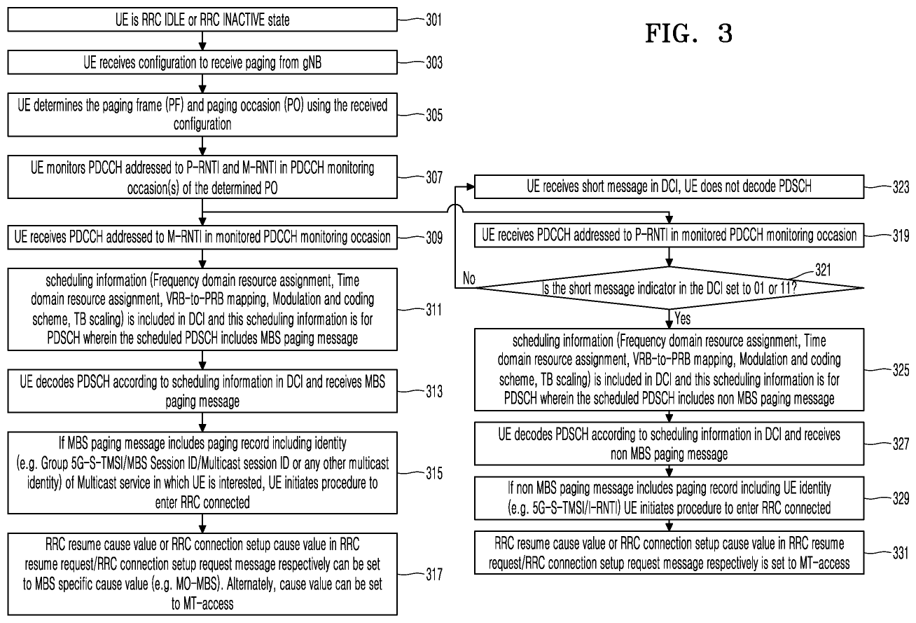

FIG. 3 is a flowchart illustrating a method, performed by a user equipment (UE), according to an embodiment of the disclosure.

Referring to FIG. 3, a method, performed by a UE, of receiving notification of multicast session activation may include operations 301 through 331. According to various embodiments of the disclosure, operations 301 through 331 may be performed by the processor 601 shown in FIG. 6.

Method 3

In one method of the disclosure, the UE operation in RRC IDLE/RRC INACTIVE is as follows:

In operation 301, the UE is the RRC IDLE or the RRC INACTIVE state

In operation 303, the UE receives the paging channel configuration from the system information (e.g. SIB1) transmitted by the gNB. The paging channel configuration includes number (N) of paging frames in DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1).

In operation 305, the UE determines the paging frame (PF) and paging occasion (PO) using the configuration received from the gNB. The procedure to determine PF and PO is same as explained earlier.

In operation 307, the UE monitors PDCCH addressed to P-RNTI in PDCCH monitoring occasion(s) of the determined PO. The UE also monitors PDCCH addressed to Multicast RNTI (M-RNTI) in PDCCH monitoring occasion(s) of the determined PO. The Multicast RNTI may be pre-defined or it may be signaled by the gNB in the RRC message or the system information. In an embodiment multiple M-RNTIs may be there wherein each M-RNTI is mapped to a multicast service/session or multicast service/session group. This mapping may be signaled by the gNB in the RRC message or system information.

In operation 309, the UE receives PDCCH addressed to M-RNTI in monitored PDCCH monitoring occasion.

In operation 311, the UE identify that scheduling information (Frequency domain resource assignment, Time domain resource assignment, the VRB-to-PRB mapping, Modulation and coding scheme, TB scaling) is included in the DCI of PDCCH addressed to M-RNTI.

In operation 313, the UE decodes PDSCH according to scheduling information in DCI and receives MBS paging message.

In operation 315, if the MBS paging message includes paging record including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested, the UE initiates procedure to enter RRC connected (i.e., connection resume procedure or connection setup procedure as defined in TS 38.331). RRC resume cause value or RRC connection setup cause value in RRC resume request/RRC connection setup request message respectively can be set to MBS specific cause value (e.g. MO-MBS), so that network is aware that the UE is entering RRC connected for MBS purpose. Alternately, cause value can be set to MT-access) (operation 317).

In an embodiment, identity (e.g. Group 5G-S-TMSI/MBS Session ID/Multicast session ID or any other multicast identity) of Multicast service in which UE is interested can be received by the UE before this procedure in NAS message from CN or in RRC message from the gNB while the UE is in the RRC connected state or it may be pre-configured in SIM/USD/USIM.

In operation 319, the UE receives PDCCH addressed to P-RNTI in monitored PDCCH monitoring occasion.

In operation 321, if the short message indicator in the DCI is set to 01 or 11, the UE performs operation 325 and if the short message indicator in the DCI is not set to 01 or 11, the UE performs operation 323.

In operation 325, the UE identify that scheduling information (Frequency domain resource assignment, Time domain resource assignment, VRB-to-PRB mapping, Modulation and coding scheme, TB scaling) is included in the DCI and this scheduling information is for PDSCH wherein the scheduled PDSCH includes non MBS paging message. The fields, Frequency domain resource assignment, Time domain resource assignment, VRB-to-PRB mapping, Modulation and coding scheme, TB scaling in DCI are not set to reserved values as in the legacy system.

In operation 327, the UE decodes PDSCH according to scheduling information in the DCI and receives non MBS paging message.

In operation 329, if non MBS paging message includes paging record including the UE identity (e.g. 5G-S-TMSI/I-RNTI, the UE initiates procedure to enter the RRC connected (i.e., connection resume procedure or connection setup procedure as defined in TS 38.331).

In operation 323, if the short message indicator in the DCI is set to 10, the UE identify that scheduling information (Frequency domain resource assignment, Time domain resource assignment, VRB-to-PRB mapping, Modulation and coding scheme, TB scaling) is included in the DCI. The fields, Frequency domain resource assignment, Time domain resource assignment, VRB-to-PRB mapping, Modulation and coding scheme, TB scaling in the DCI are set to reserved values as in the legacy system. The UE receives short message in the DCI. The UE does not decode PDSCH.

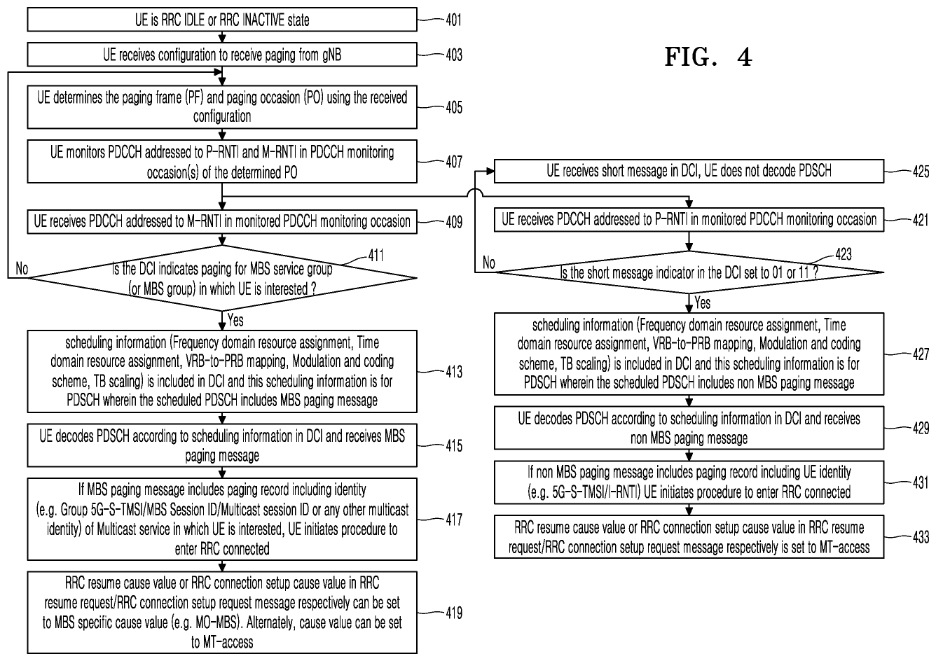

FIG. 4 is a flowchart illustrating a method, performed by a user equipment (UE), according to an embodiment of the disclosure.

Referring to FIG. 4, a method, performed by a UE, of receiving notification of multicast session activation may include operations 401 through 433. According to various embodiments of the disclosure, operations 401 through 433 may be performed by the processor 601 shown in FIG. 6.

Method 4

In one method of the disclosure, the UE operation in RRC_IDLE/RRC INACTIVE is as follows:

In operation 401, the UE is in RRC_IDLE or RRC_INACTIVE state.

In operation 403, the UE receives the paging channel configuration from the system information (e.g. SIB1) transmitted by the gNB. The paging channel configuration includes number (N) of paging frames in DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1).

In operation 405, the UE determines the paging frame (PF) and paging occasion (PO) using the configuration received from the gNB. The procedure to determine PF and PO is same as explained earlier.

In operation 407, the UE monitors PDCCH addressed to P-RNTI in PDCCH monitoring occasion(s) of the determined PO. The UE also monitors PDCCH addressed to M-RNTI (Multicast RNTI) in PDCCH monitoring occasion(s) of the determined PO. Multicast RNTI may be pre-defined or it can be signaled by the gNB in the RRC message or system information. In an embodiment multiple M-RNTIs can be there wherein each M-RNTI is mapped to a multicast service/session or multicast service/session group. This mapping can be signaled by the gNB in RRC message or system information.

In operation 409, the UE receives PDCCH addressed to M-RNTI in monitored PDCCH monitoring occasion. The scheduling information (Frequency domain resource assignment, Time domain resource assignment, VRB-to-PRB mapping, Modulation and coding scheme, TB scaling) is included in the DCI of PDCCH addressed to M-RNTI.

In operation 411, the UE checks if the DCI indicates paging for multicast service group in which the UE is interested. The DCI may include identify of one or more multicast service group(s) for which paging is there. Alternately, the DCI may include a bitmap wherein each bit in bitmap corresponds to a multicast service group and if paging is there for a multicast service group, the bit corresponding to that group in bit map is set to 1. Identity of Multicast service group can be received by the UE before this procedure in NAS message from CN or in RRC message from the gNB while the UE is in the RRC connected state or it may be pre-configured in SIM/USD/USIM. Multicast service group information can be signaled to the UE via CN (e.g. in NAS message) or RAN (e.g. in RRC message or system information). Each multicast session or multicast service can be associated with a multicast service group. Mapping between multicast session or multicast service and multicast service group identity can be signaled to the UE via CN (e.g. in NAS message) or RAN (e.g. in RRC message or system information). If UE is interested in a multicast session or multicast service, the UE monitors paging for the corresponding multicast service group.

In operation 415, if the DCI indicates paging for multicast service group in which the UE is interested, the UE decodes PDSCH according to scheduling information in the DCI and receives the MBS paging message.

In operation 417, if MBS paging message includes paging record including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MBS), so that network is aware that the UE is entering the RRC connected for MBS purpose. Alternately, cause value can be set to MT-access) (operation 419).

In an embodiment, identity (e.g. Group 5G-S-TMSI/MBS Session ID/Multicast session ID or any other multicast identity) of Multicast service in which the UE is interested may be received by the UE before this procedure in NAS message from the CN or in the RRC message from the gNB while the UE is in the RRC connected state or it may be pre-configured in SIM/USD/USIM.

In operation 421, the UE receives PDCCH addressed to P-RNTI in monitored PDCCH monitoring occasion.

In operation 423, if the short message indicator in the DCI is set to 01 or 11, the UE performs operation 427 and if the short message indicator in the DCI is not set to 01 or 11, the UE performs operation 425.

In operation 427, the UE identify that scheduling information (Frequency domain resource assignment, Time domain resource assignment, VRB-to-PRB mapping, Modulation and coding scheme, TB scaling) is included in the DCI and this scheduling information is for PDSCH wherein the scheduled PDSCH includes non MBS paging message. The fields, Frequency domain resource assignment, Time domain resource assignment, VRB-to-PRB mapping, Modulation and coding scheme, TB scaling in the DCI are not set to reserved values as in the legacy system.

In operation 429, the UE decodes PDSCH according to scheduling information in DCI and receives non MBS paging message.

In operation 431, if the non MBS paging message includes paging record including the UE identity (e.g. 5G-S-TMSI/I-RNTI, the UE initiates procedure to enter RRC connected (i.e., connection resume procedure or connection setup procedure as defined in TS 38.331).

In operation 425, if the short message indicator in the DCI is set to 10, the UE identify that scheduling information (Frequency domain resource assignment, Time domain resource assignment, VRB-to-PRB mapping, Modulation and coding scheme, TB scaling) is included in the DCI. The fields, Frequency domain resource assignment, Time domain resource assignment, VRB-to-PRB mapping, Modulation and coding scheme, TB scaling in DCI are set to reserved values as in the legacy system. The UE receives short message in DCI. The UE does not decode PDSCH.

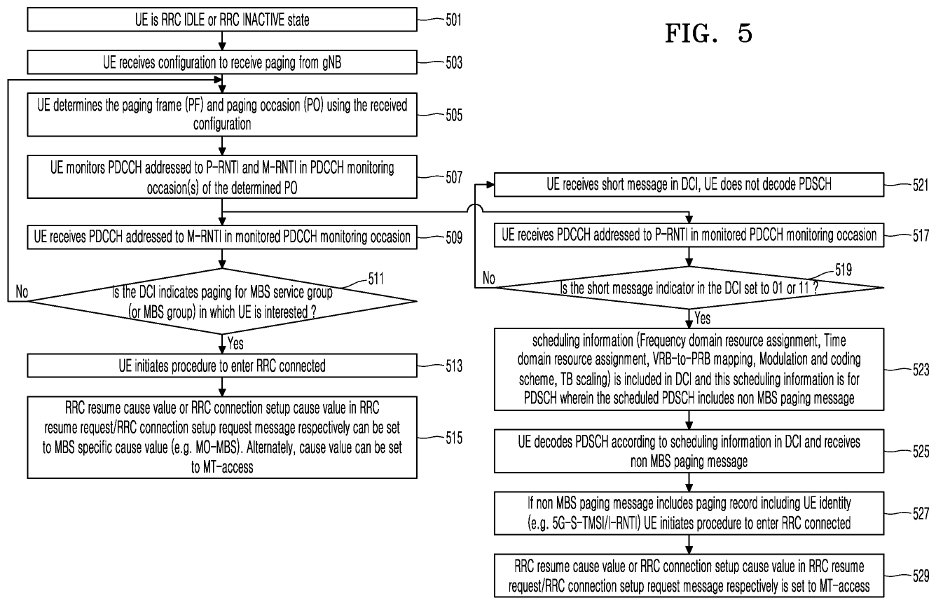

FIG. 5 is a flowchart illustrating a method, performed by a user equipment (UE), according to an embodiment of the disclosure.

Referring to FIG. 5, a method, performed by a UE, of receiving notification of multicast session activation may include operations 501 through 529. According to various embodiments of the disclosure, operations 501 through 529 may be performed by the processor 601 shown in FIG. 6.

Method 5

In one method of the disclosure, the UE operation in RRC IDLE/RRC INACTIVE is as follows:

In operation 501, the UE is the RRC IDLE or the RRC INACTIVE state

In operation 503, the UE receives the paging channel configuration from the system information (e.g. SIB1) transmitted by the gNB. The paging channel configuration includes number (N) of paging frames in DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1).

In operation 505, the UE determines the paging frame (PF) and paging occasion (PO) using the configuration received from the gNB. The procedure to determine PF and PO is same as explained earlier.

In operation 507, the UE monitors PDCCH addressed to P-RNTI in PDCCH monitoring occasion(s) of the determined PO. The UE also monitors PDCCH addressed to M-RNTI (Multicast RNTI) in PDCCH monitoring occasion(s) of the determined PO. Multicast RNTI can be pre-defined or it may be signaled by gNB in the RRC message or the system information. In an embodiment multiple M-RNTIs can be there wherein each M-RNTI is mapped to a multicast service/session or multicast service/session group. This mapping may be signaled by the gNB in the RRC message or the system information.

In operation 509, the UE receives PDCCH addressed to M-RNTI in monitored PDCCH monitoring occasion.

In operation 511, the UE checks if the DCI indicates paging (or MBS session activation/start indication) for multicast service group in which the UE is interested. The DCI may include identify of one or more multicast service group(s) for which paging (or MBS session activation/start indication) is there. Alternately, the DCI may include a bitmap wherein each bit in bitmap corresponds to a multicast service group and if paging is there for a multicast service group, the bit corresponding to that group in bit map is set to 1. Identity of Multicast service group can be received by the UE before this procedure in the NAS message from the CN or in the RRC message from the gNB while the UE is in the RRC connected state or it may be pre-configured in SIM/USD/USIM. Multicast service group information may be signaled to the UE via the CN (e.g. in NAS message) or the RAN (e.g. in RRC message or system information). Each multicast session or multicast service may be associated with a multicast service group. Mapping between multicast session or multicast service and multicast service group identity can be signaled to the UE via the CN (e.g. in NAS message) or the RAN (e.g. in RRC message or system information). If the UE is interested in a multicast session or multicast service, the UE monitors paging (or MBS session activation/start indication) for the corresponding multicast service group.

In operation 513, if the DCI indicates paging (or MBS session activation/start indication) for multicast service group in which the UE is interested, the UE initiates procedure to enter RRC connected (i.e., connection resume procedure or connection setup procedure as defined in TS 38.331). The RRC resume cause value or RRC connection setup cause value in RRC resume request/RRC connection setup request message respectively can be set to MBS specific cause value (e.g. MO-MBS), so that network is aware that the UE is entering RRC connected for MBS purpose. Alternately, cause value can be set to MT-access) (operation 515).

In operation 517, the UE receives PDCCH addressed to P-RNTI in monitored PDCCH monitoring occasion.

In operation 519, if the short message indicator in the DCI is set to 01 or 11, the UE performs operation 523 and if the short message indicator in the DCI is not set to 01 or 11, the UE performs operation 521.

In operation 523, the UE identify that scheduling information (Frequency domain resource assignment, Time domain resource assignment, VRB-to-PRB mapping, Modulation and coding scheme, TB scaling) is included in the DCI and this scheduling information is for PDSCH wherein the scheduled PDSCH includes non MBS paging message. The fields, Frequency domain resource assignment, Time domain resource assignment, VRB-to-PRB mapping, Modulation and coding scheme, the TB scaling in the DCI are not set to reserved values as in the legacy system.

In operation 525, the UE decodes PDSCH according to scheduling information in the DCI and receives non MBS paging message.

In operation 527, if the non MBS paging message includes paging record including the UE identity (e.g. 5G-S-TMSI/I-RNTI, the UE initiates procedure to enter the RRC connected (i.e., connection resume procedure or connection setup procedure as defined in TS 38.331).

In operation 521, if the short message indicator in the DCI is set to 10, the UE identify that scheduling information (Frequency domain resource assignment, Time domain resource assignment, VRB-to-PRB mapping, Modulation and coding scheme, TB scaling) is included in DCI. The fields, Frequency domain resource assignment, Time domain resource assignment, VRB-to-PRB mapping, Modulation and coding scheme, TB scaling in the DCI are set to reserved values as in the legacy system. The UE receives short message in DCI. The UE does not decode PDSCH.

Method 6

In one method of the disclosure, the UE operation in RRC_IDLE/RRC INACTIVE is as follows:

In an embodiment, the UE is the RRC_IDLE or the RRC_INACTIVE state.

The UE receives the paging channel configuration from the system information (e.g. SIB1) transmitted by gNB. The paging channel configuration includes number (N) of paging frames in DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1). The UE also receive early paging indication configuration from the system information.

The UE determines the paging frame (PF) and paging occasion (PO) using the configuration received from the gNB. The procedure to determine PF and PO is same as explained earlier. The UE determines the early paging indication occasion(s) for the determined PF/PO.

The UE monitors early paging indication occasion(s) for early paging indication. Early paging indication may be a PDCCH addressed to an RNTI (pre-defined or signaled by the gNB). Early paging indication occasions are located before the determined PF/PO.

The UE receives early paging indication:

In an embodiment, early paging indication can indicate whether there is paging for MBS and/or paging for non-MBS. If paging for the MBS is indicated (e.g. bit indicating paging for MBS is set to 1), the UE monitors PDCCH addressed to P-RNTI in PO.

In an embodiment, if subgroup info is there in early paging indication, one sub group can be for MBS to indicate paging message for MBS. If paging for this sub group is indicated (e.g. bit corresponding to MBS subgroup is set to 1), the UE monitors PDCCH addressed to P-RNTI in PO.

In an embodiment, if subgroup info is there in early paging indication, multiple sub groups can be there for MBS, each mapped to different multicast service group (or MBS session ID or TMGI). If paging for MBS sub group in which the UE is interested is indicated (e.g. bit corresponding to MBS subgroup in which UE is interested is set to 1), the UE monitors PDCCH addressed to P-RNTI in PO.

In an embodiment, Identity of Multicast service group may be received by the UE before this procedure in NAS message from CN or in RRC message from the gNB while the UE is in RRC connected state or it may be pre-configured in SIM/USD/USIM. Multicast service group information may be signaled to the UE via the CN (e.g. in NAS message) or the RAN (e.g. in RRC message or system information). Each multicast session or multicast service can be associated with a multicast service group. Mapping between multicast session or multicast service and multicast service group identity can be signaled to the UE via the CN (e.g. in NAS message) or the RAN (e.g. in RRC message or system information). If the UE is interested in a multicast session or multicast service, the UE monitors paging for the corresponding multicast service group.

The UE receives PDCCH addressed to P-RNTI in monitored PDCCH monitoring occasion of its PO. The UE checks the short message indicator field in the DCI of the received PDCCH.

If the short message indicator in the DCI is set to 00, the UE identify that scheduling information (Frequency domain resource assignment, Time domain resource assignment, VRB-to-PRB mapping, Modulation and coding scheme, TB scaling) is included in DCI and this scheduling information is for PDSCH wherein the scheduled PDSCH includes MBS paging message. The fields, Frequency domain resource assignment, Time domain resource assignment, VRB-to-PRB mapping, Modulation and coding scheme, TB scaling in DCI are not set to reserved values unlike the legacy system where these fields are set to reserved values when short message indicator in the DCI is set to 00. The UE decodes PDSCH according to scheduling information in the DCI and receives the MBS paging message.

In an embodiment, if paging message includes paging record including identity (e.g. Group 5G-S-TMSI/MBS Session ID/Multicast session ID or any other multicast identity) of Multicast service in which the UE is interested, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MBS), so that network is aware that the UE is entering the RRC connected for MBS purpose. Alternately, cause value can be set to MT-access)

In an embodiment, identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested may be received by the UE before this procedure in NAS message from the CN or in the RRC message from the gNB while the UE is in the RRC connected state or it may be pre-configured in SIM/USD/USIM.

(Alt) The UE receives early paging indication.

In an embodiment, early paging indication can indicate whether there is paging (or MBS session activation/start indication) for MBS and/or paging for non-MBS. If paging (or MBS session activation/start indication) for MBS is indicated (e.g. bit indicating paging for MBS is set to 1 in early paging indication), the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MBS), so that network is aware that the UE is entering the RRC connected for MBS purpose. Alternately, cause value can be set to MT-access).

In an embodiment, if subgroup info is there in early paging indication, one sub group can be for MBS to indicate paging (or MBS session activation/start indication) for MBS. If paging (or MBS session activation/start indication) for this sub group is indicated (e.g. bit indicating paging (or MBS session activation/start indication) for MBS sub group is set to 1 in early paging indication), the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MBS), so that network is aware that the UE is entering the RRC connected for MBS purpose. Alternately, cause value can be set to MT-access)

In an embodiment, if subgroup info is there in early paging indication, multiple sub groups may be there for MBS, each mapped to multicast service group. If paging (or MBS session activation/start indication) for MBS sub group in which the UE is interested is indicated (e.g. bit indicating paging (or MBS session activation/start indication) for MBS sub group in which UE is interested is set to 1 in early paging indication), the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MBS), so that network is aware that the UE is entering the RRC connected for MBS purpose. Alternately, cause value can be set to MT-access).

In an embodiment, identity of Multicast service group can be received by the UE before this procedure in NAS message from the CN or in the RRC message from the gNB while the UE is in the RRC connected state or it may be pre-configured in SIM/USD/USIM. Multicast service group information can be signaled to the UE via the CN (e.g. in NAS message) or the RAN (e.g. in RRC message or system information). Each multicast session or multicast service can be associated with a multicast service group. Mapping between multicast session or multicast service and multicast service group identity can be signaled to the UE via the CN (e.g. in NAS message) or the RAN (e.g. in RRC message or system information). If the UE is interested in a multicast session or multicast service, the UE monitors paging for the corresponding multicast service group.

Method 7

In one method of the disclosure, the UE operation in RRC IDLE/RRC INACTIVE is as follows:

In an embodiment, the UE is the RRC IDLE or RRC INACTIVE state.

The UE receives the MBS paging configuration from the system information (e.g. SIB1) transmitted by the gNB. The MBS paging configuration includes, paging frame offset, length of MBS DRX Cycle. firstPDCCH-MonitoringOccasionOfMulticastPO may also be optionally received from gNB in system information. The UE also receives multicast paging search space identifier (multicastpagingSearchSpace) from the system information (e.g. SIB1).

The UE determines the multicast paging frame (PF) and multicast paging occasion (PO) using the configuration received from the gNB.

Multicast PF Determination
SFN for the PF is determined by: SFN mod T=offset or (SFN+offset) mod T=0, where T is MBS DRX cycle; T and Offset are signaled. In an embodiment offset can be zero.

Multicast PO Determination
PDCCH monitoring occasion for multicast paging are indicated by multicastpagingSearchSpace.
If multicastpagingSearchSpace is zero, first set of ‘S’ PDCCH monitoring occasions for RMSI in PF is the multicast PO.
If multicastpagingSearchSpace is not zero, the valid PDCCH monitoring occasions for multicast paging which do not overlap with UL symbols (determined according to tdd-UL-DL-ConfigurationCommon) are sequentially numbered from zero starting from the first PDCCH monitoring occasion for multicast paging in the multicast PF.
Multicast PO is a set of ‘S’ consecutive PDCCH monitoring occasions where ‘S’ is the number of actual transmitted SSBs determined according to ssb-PositionsInBurst in SIB1.
Kth PDCCH monitoring occasion in multicast PO corresponds to Kth transmitted SSB where K=1, 2, . . . , S.
firstPDCCH-MonitoringOccasionOfMulticastPO can be optionally signaled. When firstPDCCH-MonitoringOccasionOfMulticastPO is present, the starting PDCCH monitoring occasion number of multicast PO is given by firstPDCCH-MonitoringOccasionOfMulticastPO parameter; otherwise, starting PDCCH monitoring occasion number of multicast PO is equal to 0.
In an embodiment, if the multicast PO overlaps with the unicast PO and the UE cannot receive PDCCH for both MBS and non MBS, the UE prioritizes reception of PDCCH for P-RNTI. Alternately, if the multicast PO overlaps with unicast PO and the UE cannot receive PDCCH for both the MBS and the non MBS, the UE prioritizes reception of PDCCH for M-RNTI. In an embodiment, whether to prioritize reception of PDCCH for P-RNTI or M-RNTI in case of overlap can be signaled by the gNB. In an embodiment, PMOs for MBS (indicated by multicastpagingSearchSpace) which overlaps with PMOs given by paging search space are considered as invalid.

The UE monitors PDCCH addressed to an M-RNTI (pre-defined or signaled by the gNB or it may be P-RNTI) in PDCCH monitoring occasion(s) of the determined multicast PO.

The UE receives PDCCH addressed to M-RNTI in monitored PDCCH monitoring occasion.
Option 1: scheduling information (Frequency domain resource assignment, Time domain resource assignment, VRB-to-PRB mapping, Modulation and coding scheme, TB scaling) is included in DCI and this scheduling information is for PDSCH wherein the scheduled PDSCH includes MBS paging message. The UE decodes PDSCH according to scheduling information in DCI and receives MBS paging message. If MBS paging message includes paging record including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively may be set to MBS specific cause value (e.g. MO-MBS), so that network is aware that the UE is entering the RRC connected for MBS purpose. Alternately, because value can be set to MT-access. identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested can be received by the UE before this procedure in NAS message from CN or in the RRC message from the gNB while the UE is in the RRC connected state or it may be pre-configured in SIM/USD/USIM.
Option 2: The UE checks if the DCI indicates paging (or MBS session activation/start indication) for multicast service group in which the UE is interested. The DCI may include identify of one or more multicast service group(s) for which paging (or MBS session activation/start indication) is there. Alternately, the DCI may include a bitmap wherein each bit in bitmap corresponds to a multicast service group and if paging is there for a multicast service group, the bit corresponding to that group in bit map is set to 1. Identity of Multicast service group can be received by the UE before this procedure in NAS message from the CN or in the RRC message from the gNB while the UE is in the RRC connected state or it can be pre-configured in SIM/USD/USIM. The multicast service group information may be signaled to the UE via the CN (e.g. in NAS message) or the RAN (e.g. in RRC message or system information). Each multicast session or multicast service can be associated with a multicast service group. Mapping between multicast session or multicast service and multicast service group identity can be signaled to the UE via the CN (e.g. in NAS message) or the RAN (e.g. in RRC message or system information). If the UE is interested in a multicast session or multicast service, the UE monitors paging (or MBS session activation/start indication) for the corresponding multicast service group. If DCI indicates paging (or MBS session activation/start indication) for multicast service group in which the UE is interested, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively may be set to MBS specific cause value (e.g. MO-MBS), so that network is aware that the UE is entering the RRC connected for MBS purpose. Alternately, cause value may be set to MT-access.
Option 3: Scheduling information (Frequency domain resource assignment, Time domain resource assignment, VRB-to-PRB mapping, Modulation and coding scheme, TB scaling) is included in the DCI of PDCCH addressed to M-RNTI. The UE checks if the DCI indicates paging for multicast service group in which the UE is interested. The DCI may include identify of one or more multicast service group(s) for which paging is there. Alternately, the DCI may include a bitmap wherein each bit in bitmap corresponds to a multicast service group and if paging is there for a multicast service group, the bit corresponding to that group in bit map is set to 1. Identity of Multicast service group can be received by the UE before this procedure in NAS message from the CN or in the RRC message from the gNB while the UE is in the RRC connected state or it can be pre-configured in SIM/USD/USIM. The multicast service group information may be signaled to the UE via the CN (e.g. in NAS message) or RAN (e.g. in RRC message or system information). Each multicast session or multicast service may be associated with a multicast service group. Mapping between multicast session or multicast service and multicast service group identity can be signaled to the UE via the CN (e.g. in NAS message) or the RAN (e.g. in RRC message or system information). If the UE is interested in a multicast session or multicast service, the UE monitors paging for the corresponding multicast service group. If the DCI indicates paging for multicast service group in which the UE is interested the UE decodes PDSCH according to scheduling information in the DCI and receives MBS paging message. If the MBS paging message includes paging record including identity (e.g. Group 5G-S-TMSI/MBS Session ID/Multicast session ID or any other multicast identity) of Multicast service in which the UE is interested, the UE initiates procedure to enter RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MBS), so that network is aware that the UE is entering RRC connected for MBS purpose. Alternately, cause value may be set to MT-access. The identity (e.g. Group 5G-S-TMSI/MBS Session ID/Multicast session ID or any other multicast identity) of Multicast service in which the UE is interested may be received by the UE before this procedure in NAS message from the CN or in the RRC message from the gNB while the UE is in the RRC connected state or it may be pre-configured in SIM/USD/USIM.

Method 8

In one method of the disclosure, the UE operation in RRC_IDLE/RRC INACTIVE is as follows:

In an embodiment, the UE is in RRC_IDLE or RRC_INACTIVE state.

The UE receives the MBS paging configuration from the system information (e.g. SIB1) transmitted by the gNB. The MBS paging configuration includes, paging frame offset, length of MBS DRX Cycle. firstPDCCH-MonitoringOccasionOfMulticastPO may also be optionally received from the gNB in system information. The UE also receives multicast paging search space identifier (multicastpagingSearchSpace) from the system information (e.g. SIB1).

The UE determines the multicast paging frame (PF) and multicast paging occasion (PO) using the configuration received from the gNB.

Multicast PF Determination
SFN for the PF is determined by: SFN mod T=offset or (SFN+offset) mod T=0, where T is MBS DRX cycle; T and Offset are signaled. In an embodiment offset can be zero.

Multicast PO Determination
PDCCH monitoring occasion for multicast paging are indicated by multicastpagingSearchSpace.
If multicastpagingSearchSpace is zero, first set of ‘S’ PDCCH monitoring occasions for RMSI in PF is the multicast PO.
If multicastpagingSearchSpace is not zero, the PDCCH monitoring occasions for multicast paging (according to search space configuration indicated by multicastpagingSearchSpace) which do not overlap with UL symbols (determined according to tdd-UL-DL-ConfigurationCommon) are sequentially numbered from zero starting from the first PDCCH monitoring occasion for multicast paging in the multicast PF.

(Alternate) The valid PDCCH monitoring occasions for multicast paging (according to search space configuration indicated by multicastpagingSearchSpace) which do not overlap with UL symbols (determined according to tdd-UL-DL-ConfigurationCommon) are sequentially numbered from zero starting from the first PDCCH monitoring occasion for multicast paging in the multicast PF.

(Alternate) The PDCCH monitoring occasions for multicast paging (according to search space configuration indicated by multicastpagingSearchSpace) which do not overlap with UL symbols (determined according to tdd-UL-DL-ConfigurationCommon) and which do not overlap with PDCCH monitoring occasions for paging (determined according to pagingSearchSpace) are sequentially numbered from zero starting from the first PDCCH monitoring occasion for multicast paging in the multicast PF.

Multicast PO is a set of ‘S’ consecutive PDCCH monitoring occasions where ‘S’ is the number of actual transmitted SSBs determined according to ssb-PositionsInBurst in SIB1.

Kth PDCCH monitoring occasion in multicast PO corresponds to Kth transmitted SSB where K=1, 2, . . . , S.

firstPDCCH-MonitoringOccasionOfMulticastPO may be optionally signaled. When firstPDCCH-MonitoringOccasionOfMulticastPO is present, the starting PDCCH monitoring occasion number of multicast PO is given by firstPDCCH-MonitoringOccasionOfMulticastPO parameter; otherwise, starting PDCCH monitoring occasion number of multicast PO is equal to 0.

In an embodiment, if the multicast PO overlaps with the unicast PO and the UE cannot receive PDCCH for both MBS and non MBS, the UE prioritizes reception of PDCCH for P-RNTI. Alternately, if multicast PO overlaps with unicast PO and the UE cannot receive PDCCH for both MBS and non MBS, the UE prioritizes reception of PDCCH for M-RNTI. In an embodiment, whether to prioritize reception of PDCCH for P-RNTI or M-RNTI in case of overlap can be signaled by the gNB. In an embodiment, PMOs for MBS (indicated by multicastpagingSearchSpace) which overlaps with PMOs given by paging search space are considered as invalid.

In an embodiment, the UE determines the early paging indication occasion(s) for the determined PF/PO. The UE monitors early paging indication occasion(s) for early paging indication. Early paging indication can be a PDCCH addressed to an RNTI (pre-defined or signaled by the gNB).

In an embodiment, the UE receives early paging indication:

In an embodiment, the UE monitors PDCCH addressed to an M-RNTI (pre-defined or signaled by the gNB or it may be P-RNTI) in PDCCH monitoring occasion(s) of the determined multicast PO.

In an embodiment, if subgroup info is there in early paging indication, multiple sub groups can be there for MBS, each mapped to multicast service group. If paging for MBS sub group in which the UE is interested is indicated, the UE monitors PDCCH addressed to an M-RNTI (pre-defined or signaled by the gNB or it may be P-RNTI) in PDCCH monitoring occasion(s) of the determined multicast PO.

In an embodiment, Identity of Multicast service group can be received by the UE before this procedure in the NAS message from the CN or in the RRC message from the gNB while the UE is in the RRC connected state or it can be pre-configured in SIM/USD/USIM. The multicast service group information can be signaled to the UE via the CN (e.g. in NAS message) or the RAN (e.g. in RRC message or system information). Each multicast session or multicast service can be associated with a multicast service group. Mapping between multicast session or multicast service and multicast service group identity may be signaled to the UE via the CN (e.g. in NAS message) or the RAN (e.g. in RRC message or system information). If the UE is interested in a multicast session or multicast service, the UE monitors paging for the corresponding multicast service group.

The UE receives the PDCCH addressed to M-RNTI in monitored PDCCH monitoring occasion. The UE identify that scheduling information (Frequency domain resource assignment, Time domain resource assignment, VRB-to-PRB mapping, Modulation and coding scheme, TB scaling) is included in the DCI and this scheduling information is for PDSCH wherein the scheduled PDSCH includes MBS paging message. The UE decodes PDSCH according to scheduling information in the DCI and receives the MBS paging message.

If the MBS paging message includes paging record including identity (e.g. Group 5G-S-TMSI/MBS Session ID/Multicast session ID or any other multicast identity, MBS Session ID can also be referred as Temporary Mobile Group Identity (TMGI) and TMGI can consists of PLMN ID and service ID) of Multicast service in which the UE is interested, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively may be set to MBS specific cause value (e.g. MO-MBS), so that network is aware that UE is entering RRC connected for MBS purpose. Alternately, because value can be set to MT-access).

In an embodiment, identity (e.g. Group 5G-S-TMSI/MBS Session ID/Multicast session ID or any other multicast identity) of Multicast service in which the UE is interested may be received by the UE before this procedure in NAS message from the CN or in the RRC message from the gNB while the UE is in the RRC connected state or it may be pre-configured in SIM/USD/USIM.

(Alt) The UE receives early paging indication. In an embodiment, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively can be set to MBS specific cause value (e.g. MO-MB S), so that network is aware that the UE is entering the RRC connected for the MBS purpose. Alternately, cause value can be set to MT-access. In an embodiment, if subgroup info is there in early paging indication, multiple sub groups can be there for the MBS, each mapped to multicast service group. If paging (or MBS session activation/start indication) for the MBS sub group in which the UE is interested is indicated, the UE initiates procedure to enter the RRC connected (i.e., connection resume procedure or connection setup procedure as defined in TS 38.331). The RRC resume cause value or the RRC connection setup cause value in the RRC resume request/RRC connection setup request message respectively may be set to MBS specific cause value (e.g. MO-MBS), so that network is aware that the UE is entering the RRC connected for MBS purpose. Alternately, cause value may be set to MT-access. Identity of Multicast service group can be received by UE before this procedure in NAS message from CN or in RRC message from gNB while the UE is in the RRC connected state or it can be pre-configured in SIM/USD/USIM. The multicast service group information can be signaled to the UE via the CN (e.g. in NAS message) or the RAN (e.g. in RRC message or system information). Each multicast session or multicast service can be associated with a multicast service group. Mapping between multicast session or multicast service and multicast service group identity can be signaled to the UE via the CN (e.g. in NAS message) or the RAN (e.g. in RRC message or system information). If the UE is interested in a multicast session or multicast service, the UE monitors paging for the corresponding multicast service group.

Method 9 (Unicast Paging)

In one method of the disclosure, the UE operation in RRC IDLE/RRC INACTIVE is as follows:

In an embodiment, the UE is in RRC IDLE or RRC INACTIVE state. The UE has received paging sub group identity from CN (e.g. in NAS message from AMF). The UE also knows the number of paging sub groups supported by the CN based on size of paging sub group identity (e.g. if size of paging sub group identity is 4 bits, 16 paging sub groups are supported) or it may be signaled to the UE by the CN (e.g. in NAS message from AMF) or it can be signaled in system information transmitted in camped cell by gNB.

The UE receives the paging channel configuration from the system information (e.g. SIB1) transmitted by the gNB. The paging channel configuration includes number (N) of paging frames in the DRX cycle, number of paging occasions per paging frame, paging frame offset, length of default DRX Cycle. firstPDCCH-MonitoringOccasionOfPO may also be optionally received from gNB in system information. The UE also receives paging search space identifier (pagingSearchSpace) from the system information (e.g. SIB1). The UE also receive early paging indication configuration from the system information. The UE also receives information about the number of paging subgroups in system information.

The UE determines the paging frame (PF) and paging occasion (PO) using the configuration received from the gNB. The procedure to determine PF and PO is same as explained earlier. The UE determines the early paging indication occasion(s) for the determined PF/PO.

The UE monitors early paging indication occasion(s) for early paging indication. Early paging indication can be a PDCCH addressed to an RNTI (pre-defined or signaled by the gNB).

UE Receives Early Paging Indication:

In an embodiment, if the number of paging sub groups per PO received from the gNB is greater than or equal to number of paging subgroups supported by CN. The UE uses the paging sub group identity received from the CN, the UE will check whether early paging indication includes paging for this paging sub group identity.

In an embodiment, if the number of paging sub groups per PO received from gNB is smaller than the number of paging subgroups supported by the CN. The UE uses the [‘paging sub group identity received from CN’ mod ‘number of paging sub groups received from gNB’] as the paging sub group identity.

In an embodiment paging sub group identity is the paging sub group identity received from the CN irrespective of number of paging subgroups signaled by the gNB.

Early paging indication can include one or more paging sub group identity for which there is paging. Alternately, Early paging indication can include a bitmap wherein each bit corresponds to a distinct paging sub group identity. Ith bit in the bitmap corresponds to paging sub group identity mod ‘number of paging groups received from gNB’, wherein the bits in bitmap are sequentially numbered from the most significant bit to least significant bit and I is an integer. Alternately, Ith bit in the bitmap corresponds to paging sub group identity mod ‘number of paging groups received from gNB’, wherein the bits in bitmap are sequentially numbered from the least significant bit to most significant bit.

If Early paging indication indicates paging for the UE's paging sub group, the UE monitors PDCCH addressed to P-RNTI in its PO.

FIG. 6 is a block diagram of a user equipment (UE) for monitoring data inactivity, according to an embodiment of the disclosure.

Referring to FIG. 6, the UE may include a transceiver 602, a memory 603, and a processor 601. The transceiver 602, the memory 603, and the processor 601 of the UE may operate according to the communication method of the UE described above. However, components of the UE are not limited thereto. For example, the UE may include more or less components than those shown in FIG. 6. In addition, the transceiver 602, the memory 603, and the processor 601 may be embodied in the form of a single chip.

The transceiver 602 may transmit and receive a signal to and from a base station. The signal may include control information and data. In this regard, the transceiver 602 may include a radio frequency (RF) transmitter up-converting and amplifying a frequency of a transmitted signal and an RF receiver performing low-noise amplification on a received signal and down-converting a frequency. However, such components of the transceiver 602 are only examples, and are not limited to the RF transmitter and the RF receiver.

Also, the transceiver 602 may receive a signal via a wireless channel and output the signal to the processor 601, and transmit a signal output from the processor 601 via the wireless channel.

The memory 603 may store a program and data required for an operation of the UE. Also, the memory 603 may store control information or data included in a signal obtained by the UE. The memory 603 may include a storage medium, such as read-only memory (ROM), random-access memory (RAM), a hard disk, a compact disc read only memory (CD-ROM), or a digital versatile disc (DVD), or a combination thereof. Also, the memory 603 may include a plurality of memories.

The processor 601 may control a series of processes such that the UE operates according to the embodiment of the disclosure. Here, in relation to operations of the processor 601, only some of the operations of the embodiments of the disclosure have been described, but the processor 601 may control all processes such that the UE may operate according to all or some of the embodiments of the disclosure.

FIG. 7 is a block diagram of a network entity for monitoring data inactivity, according to an embodiment of the disclosure.

Referring to FIG. 7, the network entity may include a transceiver 702, a memory 703, and a processor 701. The transceiver 702, the memory 703, and the processor 701 of the network entity may operate according to the communication method of the network entity described above. However, components of the network entity are not limited thereto. For example, the network entity may include more or less components than those shown in FIG. 7. In addition, the transceiver 702, the memory 703, and the processor 701 may be embodied in the form of a single chip. According to an embodiment, the network entity may include entities included in a base station and a core network. The network entity may include the NF described above, and for example, may include an AMF, an SMF, and the like.

The transceiver 702 may transmit and receive a signal to and from a UE, a network entity, or a base station. Here, the signal may include control information and data. In this regard, the transceiver 702 may include an RF transmitter up-converting and amplifying a frequency of a transmitted signal and an RF receiver performing low-noise amplification on a received signal and down-converting a frequency. However, such components of the transceiver 702 are only examples, and are not limited to the RF transmitter and the RF receiver.

Also, the transceiver 702 may receive a signal via a wireless channel and output the signal to the processor 701, and transmit a signal output from the processor 701 via the wireless channel.

The memory 703 may store a program and data required for an operation of the network entity. Also, the memory 703 may store control information or data included in a signal obtained by the network entity. The memory 703 may include a storage medium, such as read-only memory (ROM), random-access memory (RAM), a hard disk, a CD-ROM, or a DVD, or a combination thereof. Also, the memory 703 may include a plurality of memories. According to an embodiment of the disclosure, the memory 703 may store a program for supporting beam-based cooperative communication.

The processor 701 may control a series of processes such that the network entity operates according to the embodiment of the disclosure. The processor 701 may perform only some operations of the embodiments of the disclosure, but alternatively, may control all processes such that the network entity may operate according to all or some of the embodiments of the disclosure.

According to an embodiment of the disclosure, a method, performed by a user equipment (UE) in radio resource control (RRC) IDLE state or RRC INACTIVE state, in a wireless communication system, comprises receiving, from a base station (BS), paging configuration information, receiving, from the BS, physical downlink control channel (PDCCH) based on the paging configuration information, wherein the PDCCH includes scheduling information for physical downlink shared channel (PDSCH), obtaining multicast and broadcast service (MBS) paging message in the PDSCH, and performing procedure to enter RRC connected state, in case that the MBS paging message includes identity of multicast service in which the UE is interested.

In an embodiment, the method further comprises identifying short message indicator in downlink control information (DCI) of the received PDCCH and obtaining the MBS paging message responding to the identification of the short message indicator. In an embodiment, wherein value of the short message indicator is 00 or 10.

In an embodiment, the method further comprises obtaining non-MBS paging message in the PDSCH and performing procedure to enter RRC connected state, in case that the non-MB S paging message includes the UE identity. In an embodiment, the method further comprises identifying short message indicator in downlink control information (DCI) of the received PDCCH and obtaining the non-MBS paging message responding to the identification of the short message indicator, wherein value of the short message indicator is 01 or 11.

In an embodiment, wherein the PDCCH is addressed to P-RNTI or M-RNTI.

In an embodiment, the method further comprises determining paging occasion using the paging configuration information and monitoring the PDCCH based on the determined paging occasion.

According to an embodiment of the disclosure, a method, performed by a base station (BS) in a wireless communication system, comprises transmitting, to a user equipment (UE), paging configuration information, transmitting, to the UE, physical downlink control channel (PDCCH) based on the paging configuration information, wherein the PDCCH includes scheduling information for physical downlink shared channel (PDSCH), transmitting, to the UE, multicast and broadcast service (MBS) paging message via the PDSCH, and performing procedure to enter RRC connected state, in case that the MBS paging message includes identity of multicast service in which the UE is interested.

In an embodiment, the method further comprises determining short message indicator in downlink control information (DCI) of the PDCCH responding to identifying of the MBS paging message to be transmitted. In an embodiment, wherein value of the short message indicator is determined to 00 or 10.

In an embodiment, the method further comprises transmitting, to the UE, non-MBS paging message via the PDSCH and performing procedure to enter RRC connected state, in case that the non-MBS paging message includes the UE identity. In an embodiment, the method further comprises determining short message indicator in downlink control information (DCI) of the PDCCH responding to identifying of the non-MBS paging message to be transmitted, wherein value of the short message indicator is 01 or 11.

In an embodiment, wherein the PDCCH is addressed to P-RNTI or M-RNTI.

In an embodiment, the method further comprises determining paging occasion in the paging configuration information and transmitting the PDCCH based on the determined paging occasion.

According to another embodiment of the disclosure, a user equipment (UE) in radio resource control (RRC) IDLE state or RRC INACTIVE state, comprises a memory, a transceiver, and at least one processor connected with the memory and the transceiver. The at least one processor is configured to receive, from a base station (BS), paging configuration information, receive, from the BS, physical downlink control channel (PDCCH) based on the paging configuration information, wherein the PDCCH includes scheduling information for physical downlink shared channel (PDSCH), obtain multicast and broadcast service (MBS) paging message in the PDSCH, and perform procedure to enter RRC connected state, in case that the MBS paging message includes identity of multicast service in which the UE is interested.

Those skilled in the art may understand achieving all or a portion of the steps carried out by the method embodiments described above may be accomplished through commanding the associated hardware by a program, the program may be stored in a computer readable storage medium, when it is executed, one of the steps of the method embodiments or a combination thereof is included.

In addition, the functional units in the various embodiments of the application may be integrated in a processing module, or each unit may be physically present individually, or two or more units may be integrated in one module. The integrated module may be implemented in the form of hardware, and may also be achieved in the form of software function modules. The integrated module may also be stored in a computer-readable storage medium if it is implemented in the form of a software function module and is sold or used as a standalone product.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by a user equipment (UE) in radio resource control (RRC) IDLE state or RRC INACTIVE state, in a wireless communication system, the method comprising:
receiving, from a base station (BS), paging configuration information;
receiving, from the BS, a physical downlink control channel (PDCCH) based on the paging configuration information, the PDCCH including scheduling information for a physical downlink shared channel (PDSCH);
obtaining a multicast and broadcast service (MBS) paging message in the PDSCH; and
performing a procedure to enter an RRC connected state, in case that the MBS paging message includes an identity of a multicast service in which the UE is interested.

2. The method of claim 1, further comprising:
identifying a short message indicator indicating a MBS paging in downlink control information (DCI) of the received PDCCH; and
obtaining the MBS paging message responding to the identification of the short message indicator indicating the MBS paging.

3. The method of claim 2, wherein a value of the short message indicator is set to 00 for indicating the MBS paging.

4. The method of claim 1, further comprising:
obtaining a non-MBS paging message in the PDSCH; and
performing the procedure to enter the RRC connected state, in case that the non-MBS paging message includes a UE identity.

5. The method of claim 4, further comprising:
identifying a short message indicator indicating a non-MBS paging in downlink control information (DCI) of the received PDCCH; and
obtaining the non-MBS paging message responding to the identification of the short message indicator,
wherein a value of the short message indicator is 01 or 11.

6. The method of claim 1, wherein the PDCCH is addressed to a paging-radio network temporary identifier (P-RNTI) or a multicast-radio network temporary identifier (M-RNTI).

7. The method of claim 1, further comprising:
determining a paging occasion using the paging configuration information; and
monitoring the PDCCH based on the determined paging occasion.

8. The method of claim 1, further comprising:
identifying a MBS paging indicator in a short message included in a downlink control information (DCI) of the received PDCCH; and
obtaining the MBS paging message responding to the identification of the MBS paging indicator in the short message.

9. The method of claim 8,
wherein a value of the MBS paging indicator is set to 1 for indicating a MBS paging.

10. The method of claim 1, further comprising:
determining a paging occasion using the paging configuration information; and
monitoring a paging early indication before the determined paging occasion.

11. The method of claim 10, further comprising
determining if the received early paging indication indicates a paging for MBS; and
monitoring the PDCCH in the paging occasion for the MBS paging if the early paging indication indicates the paging for MBS.

12. The method of claim 10, further comprising
determining if the received early paging indication indicates the paging for MBS subgroup; and
monitoring the PDCCH in the paging occasion for the MBS paging if the early paging indication indicates the paging for the MBS subgroup.

13. A method, performed by a base station (BS) in a wireless communication system, the method comprising:
transmitting, to a user equipment (UE), paging configuration information;
transmitting, to the UE, a physical downlink control channel (PDCCH) based on the paging configuration information, the PDCCH including scheduling information for a physical downlink shared channel (PDSCH);
transmitting, to the UE, multicast and a broadcast service (MBS) paging message via the PDSCH; and
performing a procedure to enter an RRC connected state, in case that the MBS paging message includes an identity of a multicast service in which the UE is interested.

14. The method of claim 13, further comprising:
determining a short message indicator indicating a MBS paging in downlink control information (DCI) of the PDCCH responding to identifying of the MBS paging message to be transmitted.

15. The method of claim 14, wherein a value of the short message indicator is determined to 00 for indicating the MBS paging.

16. The method of claim 13, further comprising:
transmitting, to the UE, a non-MBS paging message via the PDSCH; and
performing the procedure to enter the RRC connected state, in case that the non-MBS paging message includes a UE identity.

17. The method of claim 16, further comprising:
determining a short message indicator indicating a non-MBS paging in downlink control information (DCI) of the PDCCH responding to identifying of the non-MBS paging message to be transmitted,
wherein a value of the short message indicator is 01 or 11.

18. The method of claim 13, wherein the PDCCH is addressed to a paging-radio network temporary identifier (P-RNTI) or a multicast-radio network temporary identifier (M-RNTI).

19. The method of claim 13, further comprising:
determining a paging occasion in the paging configuration information; and
transmitting the PDCCH based on the determined paging occasion.

20. A user equipment (UE) in radio resource control (RRC) IDLE state or RRC INACTIVE state, the UE comprising:
a memory;
a transceiver; and
at least one processor connected with the memory and the transceiver, the at least one processor configured to:
receive, from a base station (BS), paging configuration information,
receive, from the BS, a physical downlink control channel (PDCCH) based on the paging configuration information, the PDCCH including scheduling information for a physical downlink shared channel (PDSCH),
obtain a multicast and broadcast service (MBS) paging message in the PDSCH, and
perform a procedure to enter an RRC connected state, in case that the MBS paging message includes an identity of a multicast service in which the UE is interested.
